(19) United States
(12) Patent Application Publication
(10) Pub. No.: US 2008/0002984 A1
(43) Pub. Date: Jan. 3, 2008

(54) Optical Transmission System Using Ossb-Modulation and Signal Trasmission Method Thereof

(76) Inventors: Ui-Soo Lee, Gyeonggi-do (KR); Ki-Yeol Kim, Seoul (KR)

Correspondence Address: JONES DAY, 222 EAST 41ST ST, NEW YORK, NY, 10017, US

(21) Appl. No.: 11/662,938

(22) PCT Filed: Jun. 30, 2005
(86) PCT No.: PCT/KR05/02083

§ 371 Date: Mar. 15, 2007

(30) Foreign Application Priority Data
Sep. 16, 2004 (KR) 10-2004-0074273

(51) Int. Cl. H04B 10/12; H04B 10/04

(52) U.S. Cl. 398/140; 398/185

(57) ABSTRACT

Disclosed is an optical transmission system that executes optical transmission using OSSB (Optical Signal Side Band) modulation. This optical transmission system includes a transmitter having an OSSB modulation optical transmitting unit for selectively generating an OSSB signal in an upper or lower sideband according to an input data signal; an optical transmission medium for transmitting an optical signal output from the transmitter; and a receiver prepared at a receiving end of the optical transmission medium and including an optical filter for selectively passing only a specific sideband of the optical signal transmitted from the transmitter and outputting a digital optical signal corresponding thereto and an optical receiving unit for photo-electrically converting the optical signal output from the optical filter to restore the data signal.

### TECHNICAL FIELD

The present invention relates to an optical transmission system and a signal transmission method, and more particularly to an optical transmission system having a simplified optical signal demodulation means for transmission of data signals and a signal transmission method thereof.

### BACKGROUND ART

A ROF (Radio Over Fiber) optical transmission system widely used for transmitting ultra high frequency signals over several GHz is generally configured as shown in FIG. 1. Referring to FIG. 1, a conventional ROF optical transmission system includes a transmitter 10 having an RF modulator 11 and an optical transmitting unit 12, an optical fiber transmission path 15 for transmitting an output optical signal of the transmitter 10 to a receiving end, and a receiver 20 having an optical receiving unit 21 and an RF demodulator 22.

The RF modulator 11 of the transmitter 10 modulates baseband signals to RF (Radio Frequency) signals, and the optical transmitting unit 12 converts the modulated RF signals to analog optical signals and then outputs them.

Generally, an analog optical modulating method may be classified into a direct modulating method for modulating power of an optical signal by directly changing an input current of a laser diode used as a light source, and an indirect modulating method for modulating an optical signal having a certain intensity, output from a laser diode, by using an external optical modulator such as EAM (Electro-Absorption Modulator) or MZM (Mach-Zehnder Modulator). Here, in a usable frequency not less than 10 GHz, the indirect modulating method is used in consideration of limits of frequency characteristics of the laser diode and chirping that is an nonlinear factor caused in a signal when the signal is modulated by the laser diode.

The optical receiving unit 21 of the receiver 20 converts an optical signal received through the optical fiber transmission path 15 into an electric RF signal, and the RF demodulator 22 demodulates the converted RF signal into a baseband signal. For such signal processing, the receiver 20 is basically provided with a frequency synthesizer and a mixer for down-conversion of an RF signal.

FIG. 2 shows a waveform for better understanding about the ROF optical transmission system shown in FIG. 1. Referring to FIG. 2, the RF modulator 11 of the transmitter 10 receives a baseband data signal S₁ and converts a carrier to generate an RF signal S₂. At this time, the baseband data signal S₁ input to the RF modulator 11 is up-converted to a signal in a carrier frequency band generated by a predetermined local oscillator. This modulated RF signal S₂ is again input to the optical transmitting unit 12, and then optically modulated by the direct modulating method or the indirect modulating method and then output as a modulated optical signal S₃.

The modulated optical signal S₃ has a structure that a spectrum of RF signal is included with a frequency separation corresponding to a carrier frequency w_{RF} of the RF signal at both sides centering around an optical carrier w_{OPT}. The RF signal spectrums formed in both sidebands are mixed up with each other during photoelectric conversion by a photodiode of the optical receiving unit 21 to generate an RF signal S₄. Finally, the RF electric signal output from the photodiode passes through the RF demodulator 22 so as to be converted into a baseband signal S₅. Here, the demodulating process at the RF demodulator 22 may be executed in various ways in accordance with a modulating method of the RF modulator 1, and it is generally executed in a way that a signal output from the local oscillator and an RF signal output from the photodiode are mixed and down-converted into an intermediate frequency or a baseband, and then they are processed.

As mentioned above, the conventional ultra high frequency ROF optical transmission system should be provided with a high frequency local oscillator, a PLL (Phase Locked Loop) for compensating a phase of the local oscillator, and a mixer for down-converting a signal into an intermediate frequency or a baseband so as to restore a baseband data signal. However, it is not easy to implement the above RF modules operated at high frequency, and it also becomes a factor of complicating the configuration of the system.

### DISCLOSURE OF INVENTION

### Technical Problem

The present invention is designed in consideration of the above problems, and therefore it is an object of the invention to provide an optical transmission system using OSSB (Optical Signal Side Band) modulation, which may simplify a demodulator by transmitting/receiving a data signal by utilization of sidebands of a modulated optical signal, and a signal transmission method thereof.

### Technical Solution

In order to accomplish the above object, the present invention provides an optical transmission system, which includes a transmitter having an OSSB modulation optical transmitting unit for selectively generating an OSSB signal in an upper or lower sideband according to an input data signal; an optical transmission medium for transmitting an optical signal output from the transmitter; and a receiver prepared at a receiving end of the optical transmission medium and including an optical filter for selectively passing only a specific sideband of the optical signal transmitted from the transmitter and outputting a digital optical signal corresponding thereto and an optical receiving unit for photoelectrically converting the optical signal output from the optical filter to restore the data signal.

The data signal input to the transmitter may be corresponding to a baseband signal or an RF-modulated signal.

The OSSB modulation optical transmitting unit preferably includes any of an OSSB modulator using combination of an amplitude modulator and a phase modulator, a dual electrode MZM and a Sagnac interferometer.

The optical filter may be a fiber grating filter, a Fabry-Perot filter, a film filter or a sound-optic filter.

The optical transmission medium may be corresponding to an optical fiber or a free space.

In another aspect of the invention, there is also provided a signal transmission method, which includes (a) selectively generating an OSSB-modulated optical signal in an upper or lower sideband according to an input data signal and then transmitting the optical signal to a receiving end; (b) selectively filtering a specific sideband of the received optical signal to output a digital optical signal corresponding thereto; and (c) photoelectrically converting the digital optical signal to restore the data signal.

In the step (a), the input data signal may be corresponding to a baseband signal or an RF-modulated signal.

In the step (a), the OSSB modulation is preferably executed by any of an OSSB modulator using combination of an amplitude modulator and a phase modulator, a dual electrode MZM and a Sagnac interferometer.

In the step (b), the filtering is preferably executed by any of a fiber grating filter, a Fabry-Perot filter, a film filter and a sound-optic filter

In the step (a), the optical transmission medium may be corresponding to an optical fiber or a free space.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 shows configuration of an optical transmission system according to the prior art;

FIG. 2 shows a waveform corresponding to each signal shown in FIG. 1;

FIG. 3 shows configuration of an optical transmission system according to a preferred embodiment of the present invention; and

FIG. 4 shows a waveform corresponding to each signal shown in FIG. 3.

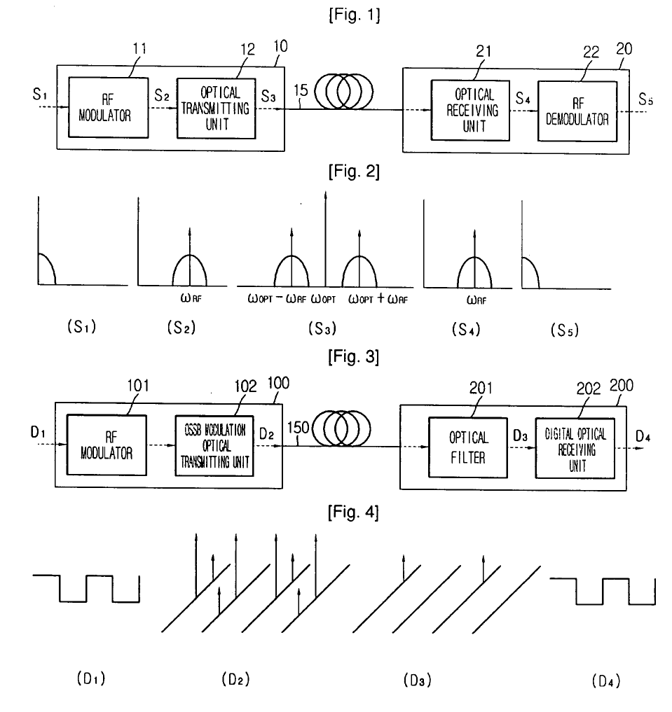

### BEST MODE FOR CARRYING OUT THE INVENTION

The present invention will be described in detail referring to the drawings, the terms used should not be construed as limited to general and dictionary meanings but based on the meanings and concepts of the invention on the basis of the principle that the inventor is allowed to define terms appropriate for the best explanation. Therefore, the description herein the scope of the invention be understood that other and modifications could be made thereto without departing from the spirit and scope of the invention.

FIG. 3 shows configuration of an optical transmission system according to a preferred embodiment of the present invention.

Referring to FIG. 3, the optical transmission system of the present invention includes a transmitter 100 having an OSSB modulation optical transmitting unit 102, an optical transmission medium 150 for forwarding of an optical signal, and a receiver 200 having an optical filter 201 and a digital optical receiving unit 202.

A data signal to be input to the transmitter 100 and then OSSB-modulated may be an RF signal as well as a baseband signal. In case a baseband signal is input, the transmitter 100 is further provided with an RF modulator 101 for modulating the baseband signal into an RF signal.

The OSSB modulation optical transmitting unit 102 OSSB-modulates a data signal and then outputs an optical signal. Here, as a means for the OSSB modulation, any of an OSSB modulator using combination of an amplitude modulator and a phase modulator, a dual electrode MZM and a Sagnac interferometer is preferably adopted, and also an OSSB modulator using an optical filter 201 may also be adopted.

The OSSB modulation optical transmitting unit 102 selectively outputs OSSB signals in an upper sideband or a lower sideband according to an input data signal.

That is to say, an OSSB signal having an upper sideband is generated in a certain time range and an OSSB signal having a lower sideband is generated in another time range according to a data signal. More specifically, in case a dual electrode MZM is used as an OSSB modulation means as an example, whenever RF signals input to both electrodes of the dual electrode MZM have a phase difference of p/2 or −p/2, one sideband of the optical carrier is selectively removed so that an OSSB signal having the other sideband is generated. Here, if a phase difference of the carriers of the RF signals applied to both electrodes becomes p/2 or −p/2 according to the input of a data signal, an OSSB signal having an upper sideband is generated in a certain time range and an OSSB signal having a lower sideband is generated in another time range according to the input data signal.

A modulated optical signal output from the OSSB modulation optical transmitting unit 102 preferably travels along the optical transmission medium 150 corresponding to the optical fiber transmission path and is then transmitted to the receiving end. Here, the optical transmission medium 150 is not limited to an optical fiber, but may also be a free space.

The receiver 200 positioned at the receiving end of the optical transmission medium 150 is provided with the optical filter 201 and the digital optical receiving unit 202.

When an OSSB-modulated optical signal is input, the optical filter 201 selectively passes one sideband and intercepts an optical carrier and the other sideband so as to generate a digital optical signal corresponding to a sideband spectrum of the optical signal. For example, in case the optical filter 201 has a frequency characteristic that passes only a frequency range of an upper sideband and does not pass an optical carrier and a frequency range of a lower sideband, the optical filter 201 outputs a high signal only in a time range of the upper sideband and outputs a low signal in the other time range. As this optical filter 201, any of a fiber grating filter, a Fabry-Perot filter, a film filter and a sound-optic filter is preferably used.

A digital optical signal generated in the optical filter 201 is preferably input to the digital optical receiving unit 202 having a photodiode and converted into a digital electric signal so that it is restored to a data signal.

Now, the process of executing data transmission by the optical transmission system according to the preferred embodiment of the present invention is described with reference to the waveform of FIG. 4.

The RF modulator 101 of the transmitter 100 receives a baseband data signal D and modulates a carrier to generate an RF signal. At this time, the baseband data signal D input to the RF modulator 101 is up-converted into a signal in a carrier frequency band generated by a predetermined local oscillator (not shown).

This modulated RF data signal is again converted into an OSSB signal D₂ by the OSSB modulation optical transmitting unit 102 and is then transmitted to a receiving end. The OSSB modulation optical receiving unit 102 selectively generates an OSSB signal in an upper or lower sideband according to the RF data signal. Accordingly, at an output end of the OSSB modulation optical transmitting unit 102, the OSSB signal D₂ having spectrum distribution of the upper and lower sidebands corresponding to the input data signal D₃ is output.

The OSSB signal D₂, which is a modulated optical signal, is transmitted along the optical transmission medium 150 and is then input to the optical filter 201 of the receiver 200. The optical filter 201 selectively filters one sideband as for the input OSSB signal D₂ and intercepts an optical carrier and the other sideband to output a digital optical signal D₃. Thus, the digital optical signal D₃ output from the optical filter 201 has a digital value substantially corresponding to the data signal D₁, in accordance to the sideband distribution of the filtered OSSB signal.

Finally, the digital optical signal D₃ generated in the optical filter 201 is input to the digital optical receiving unit 202 and then photoelectrically converted into a digital electric signal D₄ so as to be restored to a data signal D₁.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

According to the present invention, there is no need for various RF modules for demodulation of data signals, so the optical transmission system may have simple configuration and be conveniently implemented.

Thus, in case the present invention is applied to an ultra high frequency ROF system over several GHz, signal loss caused by various RF modules does not occur, thereby giving excellent transmission characteristics.

1. An optical transmission system, comprising:
a transmitter having an OSSB (Optical Signal Side Band) modulation optical transmitting unit for selectively generating an OSSB signal in an upper or lower sideband according to an input data signal;
an optical transmission medium for transmitting an optical signal output from the transmitter; and
a receiver prepared at a receiving end of the optical transmission medium and including an optical filter for selectively passing only a specific sideband of the optical signal transmitted from the transmitter and outputting a digital optical signal corresponding thereto and an optical receiving unit for photoelectrically converting the optical signal output from the optical filter to restore the data signal.

2. The optical transmission system according to claim 1,
wherein the data signal input to the transmitter is a baseband signal or an RF-modulated (Radio Frequency-modulated) signal.

3. The optical transmission system according to claim 1,
wherein the OSSB modulation optical transmitting unit includes any of an OSSB modulator using combination of an amplitude modulator and a phase modulator, a dual electrode MZM (Mach-Zehnder Modulator) and a Sagnac interferometer.

4. The optical transmission system according to claim 1,
wherein the optical filter is any of a fiber grating filter, a Fabry-Perot filter, a film filter and a sound-optic filter.

5. The optical transmission system according to any of claims 1 to 4,
wherein the optical transmission medium is an optical fiber or a free space.

6. A signal transmission method, comprising:
(a) selectively generating an OSSB-modulated optical signal in an upper or lower sideband according to an input data signal and then transmitting the optical signal to a receiving end;
(b) selectively filtering a specific sideband of the received optical signal to output a digital optical signal corresponding thereto; and
(c) photoelectrically converting the digital optical signal to restore the data signal.

7. The signal transmission method according to claim 6,
wherein, in the step (a), the input data signal is a baseband signal or an RF-modulated signal.

8. The signal transmission method according to claim 6,
wherein, in the step (a), the OSSB modulation is executed by any of an OSSB modulator using combination of an amplitude modulator and a phase modulator, a dual electrode MZM and a Sagnac interferometer.

9. The signal transmission method according to claim 6,
wherein, in the step (b), the filtering is executed by any of a fiber grating filter, a Fabry-Perot filter, a film filter and a sound-optic filter

10. The signal transmission method according to any of claims 6 to 9,
wherein, in the step (a), the optical transmission medium is an optical fiber or a free space.
